(19) United States
(12) Patent Application Publication
(10) Pub. No.: US 2020/0339768 A1
(43) Pub. Date: Oct. 29, 2020

(54) COMPOSITION FOR FIBER-REINFORCED RESIN, PRODUCTION METHOD THEREFOR, FIBER-REINFORCED RESIN, AND FORMED ARTICLE

(71) Applicant: JSR CORPORATION, Minato-ku (JP)

(72) Inventors: Rikimaru KUWABARA, Minato-ku (JP); Akihiko MORIKAWA, Minato-ku (JP); Shuugo MAEDA, Minato-ku (JP)

(73) Assignee: JSR CORPORATION, Minato-ku (JP)

(21) Appl. No.: 16/464,486

(22) PCT Filed: Nov. 14, 2017
(86) PCT No.: PCT/JP2017/040855

§ 371 Date: May 28, 2019

(30) Foreign Application Priority Data
Nov. 29, 2016 (JP) 2016-230972

(51) Int. Cl. C08J 5/04; C08L 53/02

(52) U.S. Cl. CPC C08J 5/042; C08J 2453/02; C08J 2353/02; C08L 53/025

(57) ABSTRACT

Provided is a composition for a fiber-reinforced resin, for producing a fiber-reinforced resin capable of providing a formed article excellent in mechanical strength (e.g., impact resistance and flexural strength). The composition for a fiber-reinforced resin includes a block polymer (A), and a polymer (B) including at least one functional group selected from the group consisting of an epoxy group, an oxazoline group, and an acid anhydride structure.

### TECHNICAL FIELD

The present invention relates to a composition for a fiber-reinforced resin and a production method therefor, a fiber-reinforced resin including the composition, and a formed article obtained by forming the fiber-reinforced resin.

### BACKGROUND ART

A fiber-reinforced plastic (FRP) is a material produced by binding reinforcing fibers (e.g., glass fibers and carbon fibers) using a resin. The FRP is a composite material that exhibits excellent mechanical strength, heat resistance, formability, and the like. Therefore, the FRP is widely used in a wide variety of fields including the airplane industry, the space industry, the vehicle industry, the building material industry, the sports industry, and the like.

In particular, a carbon fiber-reinforced plastic (CFRP) is characterized by high strength and reduced weight. For example, a thermosetting epoxy resin is mainly reinforced using carbon fibers, and is used as a structural material for producing an airplane. Meanwhile, in recent years, an FRP using a thermoplastic resin has attracted attention because the FRP has such a feature that a forming cycle can be reduced in addition to the above-mentioned characteristics.

In the CFRP using the thermoplastic resin as described above, use has been made of carbon long fiber-reinforced resin pellets obtained by impregnating carbon long fibers with a thermoplastic resin while aligning the carbon long fibers under tension, and then cutting the resulting fiber-reinforced resin rod (strand) to an arbitrary length (see, for example, Patent Literature 1). A method involving impregnating a mat formed of fibers (non-woven fabric or the like) with a thermoplastic resin to produce a CFRP has also been investigated (see, for example, Patent Literature 2).

### CITATION LIST

### Patent Literature

[PTL 1] JP-A-05-112657
[PTL 2] JP-A-2014-125532

### SUMMARY OF INVENTION

### Technical Problem

However, the CFRP produced by the above-mentioned method has insufficient adhesiveness between the carbon fibers and a matrix resin in some cases, and is also insufficient in terms of mechanical properties (e.g., flexural strength) in some cases. Accordingly, when a load (e.g., flexural load) is applied to the CFRP produced by the above-mentioned method, cracks sometimes occur at an interface between the carbon fibers and the matrix resin. The cracks that have thus occurred are sometimes propagated to other interfaces between the carbon fibers and the matrix resin to induce cracks across the formed article, whereby the formed article breaks.

An object of several aspects of the invention is to solve at least some of the above-mentioned problems, and provide a fiber-reinforced resin capable of providing a formed article excellent in mechanical strength (e.g., impact resistance and flexural strength). Another object of several aspects of the invention is to provide a composition for producing the fiber-reinforced resin and a production method therefor.

### Solution to Problem

The invention was conceived in order to solve at least some of the above problems, and may be implemented as described below (see the following aspects and application examples).

### Application Example 1

According to one aspect of the invention, there is provided a composition for a fiber-reinforced resin, including: a block polymer (A); and a polymer (B) including at least one functional group selected from the group consisting of an epoxy group, an oxazoline group, and an acid anhydride structure.

### Application Example 2

In the composition for a fiber-reinforced resin according to Application Example 1, the polymer (A) and the polymer (B) may each have a weight average molecular weight of 10,000 or more.

### Application Example 3

In the composition for a fiber-reinforced resin according to Application Example 1 or 2, the polymer (A) may have a storage modulus under an atmosphere at 23° C. of 5 MPa or more.

### Application Example 4

In the composition for a fiber-reinforced resin according to any one of Application Examples 1 to 3, the polymer (A) may include a styrene block.

### Application Example 5

According to one aspect of the invention, there is provided a production method for a composition for a fiber-reinforced resin, including a step of melt-mixing: a block polymer (A); and a polymer (B) including at least one functional group selected from the group consisting of an epoxy group, an oxazoline group, and an acid anhydride structure.

### Application Example 6

In the production method for a composition for a fiber-reinforced resin according to Application Example 5, the polymer (A) and the polymer (B) may each have a weight average molecular weight of 10,000 or more.

### Application Example 7

According to one aspect of the invention, there is provided a fiber-reinforced resin, including: the composition for a fiber-reinforced resin of any one of Application Examples 1 to 4; a thermoplastic resin (C); and carbon fibers (D).

### Application Example 8

According to one aspect of the invention, there is provided a formed article, which is obtained by forming the fiber-reinforced resin of Application Example 7.

### Advantageous Effects of Invention

According to the fiber-reinforced resin including the composition for a fiber-reinforced resin according to the invention, adhesion between the fibers and the matrix resin is improved, and hence the formed article excellent in mechanical strength (e.g., impact resistance and flexural strength) is obtained.

### DESCRIPTION OF EMBODIMENTS

The exemplary embodiments of the invention are described in detail below. Note that the invention is not limited to the following exemplary embodiments. It is intended that the invention includes various modifications that can be implemented without departing from the scope of the invention. The concept “(meth)acrylic acid • • • ” used herein encompasses both of “acrylic acid • • • ” and “methacrylic acid • • • ”. In addition, the concept” • • • (meth)acrylate” used herein encompasses both of “• • • acrylate” and “• • • methacrylate”.

Note that the term “block polymer (A)” may be referred to herein as “component (A)”, the term “polymer (B) including at least one functional group selected from the group consisting of an epoxy group, an oxazoline group, and an acid anhydride structure” may be referred to herein as “component (B)”, the term “thermoplastic resin (C)” may be referred to herein as “component (C)”, and the term “carbon fibers (D)” may be referred to herein as “component (D)”.

### 1. Composition for Fiber-Reinforced Resin

Normally, when a load (e.g., flexural load) is applied to an FRP formed article, adhesion between the fibers and the matrix resin is liable to become insufficient, and cracks are liable to occur at an interface between the fibers and the matrix resin. The cracks that have thus occurred are propagated through other interfaces between the fibers and the matrix resin to induce cracks across the formed article, whereby the formed article breaks.

In order to suppress the occurrence of cracks due to the above-mentioned mechanism, it is necessary to increase the interfacial adhesion between the fibers and the matrix resin. A composition for a fiber-reinforced resin according to one embodiment of the invention that implements such an increase in interfacial adhesion includes a block polymer (A), and a polymer (B) including at least one functional group selected from the group consisting of an epoxy group, an oxazoline group, and an acid anhydride structure, and/or includes a polymer obtained by allowing those polymers to react with each other. Each component included in the composition for a fiber-reinforced resin according to one embodiment of the invention is described below.

1.1. Polymer (A)

The composition for a fiber-reinforced resin according to one embodiment of the invention includes the block polymer (A). It is considered that the component (A) improves mutual solubility with the component (B) or the component (C) in a formed article according to one embodiment of the invention to strongly bond the component (C) serving as a matrix resin in a fiber-reinforced resin to the component (D), so that the occurrence of cracks at the interface between the component (C) and the component (D) when a load (e.g., flexural load) is applied can be suppressed, and hence the mechanical strength (e.g., flexural strength and Charpy impact strength) of the formed article is improved.

The component (A) to be used in one embodiment of the invention is not particularly limited as long as the component (A) is a block polymer. The component (A) preferably includes at least one functional group selected from the group consisting of an amino group, a carboxyl group, an oxazoline group, and an acid anhydride structure. Note that the term “amino group” used herein refers to any one of a primary amino group (—NH₂), a secondary amino group (—NHR, where R is a hydrocarbon group), and a tertiary amino group (—NRR′, where R and R′ are each a hydrocarbon group). The concept “carboxyl group” used herein encompasses not only —COOH, but also —COOM (M is a monovalent metal ion). Specific examples of the “acid anhydride structure” include carboxylic anhydride structures, such as an acetic anhydride structure, a propionic anhydride structure, an oxalic anhydride structure, a succinic anhydride structure, a phthalic anhydride structure, a maleic anhydride structure, and a benzoic anhydride structure. The amino group, the carboxyl group, the oxazoline group, and the acid anhydride structure may each be protected with a protecting group.

The total number of amino groups, carboxyl groups, oxazoline groups, and acid anhydride structures per molecular chain of the component (A) is preferably 0.1 or more, more preferably 0.3 or more, and particularly preferably 0.5 or more. When the total number of amino groups, carboxyl groups, oxazoline groups, and acid anhydride structures per molecular chain of the component (A) falls within the above-mentioned range, it is considered that adhesion to the carbon fibers (D) further increases, and the mechanical strength of a formed article obtained by forming a fiber-reinforced resin according to one embodiment of the invention is further improved.

The polystyrene-equivalent weight average molecular weight (Mw) of the component (A) determined by gel permeation chromatography (GPC) is preferably 10,000 or more, more preferably 20,000 or more and 3,000,000 or less, and particularly preferably 30,000 or more and 2,000,000 or less. The melt flow rate (MFR) (230° C., 2.16 kg) of the component (A) measured in accordance with JIS K7210 is preferably from 0.1 g/10 min to 200 g/10 min.

The lower limit of the storage modulus of the component (A) under an atmosphere at 23° C. is preferably 5 MPa, more preferably 5.5 MPa, and particularly preferably 6 MPa. The upper limit of the storage modulus is preferably 300 MPa, more preferably 250 MPa, and particularly preferably 230 MPa. When the storage modulus of the component (A) under an atmosphere at 23° C. falls within the above-mentioned range, a formed article excellent in balance between the flexural strength and Charpy impact strength can be easily obtained. Note that the “storage modulus under an atmosphere at 23° C.” is the average of storage moduli E′ (MPa) within the strain range of from 0.01% to 1% in viscoelasticity measurement using a viscoelasticity measurement apparatus under an atmosphere at 23° C. and a frequency of 1 Hz.

The storage modulus of the component (A) under an atmosphere at 23° C. may be controlled by adjusting, for example, the type and amount of a polar group to be introduced into the polymer, and the molecular weight and cross-linking degree of the polymer.

The content ratio of the component (A) in the composition for a fiber-reinforced resin according to one embodiment of the invention is preferably from 10 parts by mass to 90 parts by mass, and more preferably from 15 parts by mass to 85 parts by mass, in 100 parts by mass in total of the component (A) and the component (B).

The component (A) may include a repeating unit derived from a conjugated diene. The component (A) may include a repeating unit derived from a monomer other than the conjugated diene as required. The component (A) is a block polymer including repeating units formed by an identical monomer, and preferably includes a styrene block. When the component (A) includes the styrene block, the mutual solubility with the component (B) or the component (C) can be further improved, and the component (C) and the component (D) can be more strongly bonded to each other. The repeating units of the component (A) are described in detail below.

1.1.1. Conjugated Diene

Examples of the conjugated diene include 1,3-butadiene, isoprene, 2,3-dimethyl-1,3-butadiene, 1,3-pentadiene, 2-methyl-1,3-octadiene, 1,3-hexadiene, 1,3-cyclohexadiene, 4,5-diethyl-1,3-octadiene, 3-butyl-1,3-octadiene, myrcene, farnesene, chloroprene, and the like. It is preferable that 1,3-butadiene or isoprene be included.

1.1.2. Monomer Other than Conjugated Diene

The component (A) may include a repeating unit derived from a compound other than a conjugated diene. An aromatic alkenyl compound is preferable as such a compound.

Specific examples of the aromatic alkenyl compound include styrene, tert-butyl styrene, alpha-methyl styrene, p-methyl styrene, p-ethyl styrene, divinylbenzene, 1,1-diphenyl styrene, 1-vinylnaphthalene, 2-vinylnaphthalene, 2-vinylanthracene, 9-vinylanthracene, p-vinylbenzyl propyl ether, p-vinylbenzyl butyl ether, p-vinylbenzyl hexyl ether, p-vinylbenzyl pentyl ether, m-N,N-diethyl aminoethyl styrene, p-N,N-diethyl aminoethyl styrene, p-N,N-dimethyl aminoethyl styrene, o-vinylbenzyl dimethyl amine, p-vinylbenzyl dimethyl amine, p-vinylbenzyl diethylamine, p-vinylbenzyl di(n-propyl)amine, p-vinylbenzyl di(n-butyl)amine, vinylpyridine, 2-vinylbiphenyl, 4-vinylbiphenyl, p-[N,N-bis(trimethylsilyl)amino]styrene, p-[N,N-bis(trimethylsilyl)aminomethyl]styrene, p-2-[N,N-bis(trimethylsilyl)amino]ethyl styrene, m-[N,N-bis(trimethylsilyl)amino]styrene, p-(N-methyl-N-trimethylsilylamino)styrene, p-(N-methyl-N-trimethylsilylaminomethyl)styrene, and the like. Those monomers may be used either alone or in combination.

When the component (A) includes a repeating unit derived from a conjugated diene and a repeating unit derived from an aromatic alkenyl compound, it is preferable that the component (A) include the repeating unit derived from a conjugated diene and the repeating unit derived from an aromatic alkenyl compound in a mass ratio of from 100:0 to 20:80, and more preferably from 90:10 to 60:40.

1.1.3. Configuration of Polymer

The component (A) is a block polymer, and is more preferably a block polymer that includes two or more polymer blocks selected from the following polymer blocks A to D.
Polymer block A: A polymer block that includes a repeating unit derived from an aromatic alkenyl compound in a ratio of 80 mass % or more
Polymer block B: A polymer block that includes a repeating unit derived from a conjugated diene in a ratio of 80 mass % or more, and has a vinyl bond content of less than 30 mol %
Polymer block C: A polymer block that includes a repeating unit derived from a conjugated diene in a ratio of 80 mass % or more, and has a vinyl bond content of 30 mol % or more and 90 mol % or less
Polymer block D: A random copolymer block that includes a repeating unit derived from a conjugated diene and a repeating unit derived from an aromatic alkenyl compound, and excludes the polymer blocks A to C

When the component (A) includes the polymer block C, molecular entanglement and mutual solubility with an olefin-based resin (i.e., component (C)) are improved, and the mechanical strength of the resulting formed article can be further improved. The vinyl bond content in the polymer block C is more preferably 50 mol % or more and 90 mol % or less. It is preferable that the polymer block C have been hydrogenated so that molecular entanglement and mutual solubility with an olefin-based resin are significantly improved.

Note that the term “vinyl bond content” used herein refers to the total content (mol %) of repeating units derived from a conjugated diene that are included in the unhydrogenated polymer through a 1,2-bond or a 3,4-bond (among a 1,2-bond, a 3,4-bond, and a 1,4-bond). The vinyl bond content (1,2-bond content and 3,4-bond content) may be calculated by infrared absorption spectrometry (Morello method).

1.1.4. Hydrogenation

It is preferable that the component (A) be a hydrogenated polymer so that the weatherability and the mechanical strength of the formed article according to one embodiment of the invention are improved. In particular, when an olefin-based resin is used as the component (C), it is possible to significantly improve the molecular entanglement and the mutual solubility of the component (A) and the olefin-based resin, and further improve the adhesion between the component (C) and the component (D) by utilizing a hydrogenated polymer as the component (A).

The hydrogenation rate of the polymer is preferably 60% or more, and more preferably 80% or more, based on the double bonds (e.g., vinyl bond).

The weight average molecular weight (Mw) of the hydrogenated polymer is preferably 10,000 or more, more preferably 20,000 or more and 3,000,000 or less, and particularly preferably 30,000 or more and 2,000,000 or less. Note that the term “weight average molecular weight” used herein refers to a polystyrene-equivalent weight average molecular weight determined by gel permeation chromatography (GPC).

1.1.5. Method for Producing Component (A)

The component (A) may be produced using the method disclosed in Japanese Patent No. 5402112, Japanese Patent No. 4840140, WO2003/029299, WO2014/014052, or the like, for example. A commercially available product may be used as the component (A) as appropriate. For example, products available under the trade names “DR8660” and “DR4660” manufactured by JSR Corporation, products available under the trade names “Tuftec M1913” and “Tuftec MP10” manufactured by Asahi Kasei Chemicals Corporation, and a product available under the trade name “UMEX 1001” manufactured by Sanyo Chemical Industries, Ltd. may be used.

1.2. Polymer (B)

The composition for a fiber-reinforced resin according to one embodiment of the invention includes the polymer (B) including at least one functional group selected from the group consisting of an epoxy group, an oxazoline group, and an acid anhydride structure. It is considered that the component (B) is excellent in mutual solubility with the component (A), and particularly contributes to improving the flexural strength of the formed article. When the component (A) includes at least one functional group selected from the group consisting of an amino group, a carboxyl group, an oxazoline group, and an acid anhydride structure, it is considered that the component (B) reacts with the component (A) and further reacts with the component (D) as well, to thereby serve as an intermediary for strongly bonding the component (A) to the component (D). It is considered that, as a result, the occurrence of cracks at the interface between the component (C) and the component (D) when a load (e.g., flexural load) is applied to the formed article according to one embodiment of the invention is suppressed, and the mechanical strength (e.g., flexural strength and Charpy impact strength) of the formed article is improved.

Note that, in the fiber-reinforced resin according to one embodiment of the invention to be described later, the content ratio of the component (B) is preferably from 1 part by mass to 150 parts by mass, and more preferably from 1.5 parts by mass to 100 parts by mass, based on 100 parts by mass of the carbon fibers (D). When the content ratio of the component (B) falls within the above-mentioned range, it is considered that the function as an intermediary between the component (A) and the component (D) is further improved, and hence the flexural strength and Charpy impact strength of the formed article are further improved.

Examples of the acid anhydride structure in the component (B) include carboxylic acid anhydride structures, such as an acetic anhydride structure, a propionic anhydride structure, an oxalic anhydride structure, a succinic anhydride structure, a phthalic anhydride structure, a maleic anhydride structure, and a benzoic anhydride structure. Each of the functional groups (i.e., epoxy group, oxazoline group, and acid anhydride structure) in the component (B) may be protected by a protecting group.

Of the functional groups in the component (B), an epoxy group is preferable. Examples of the polymer having an epoxy group include a polyolefin-glycidyl (meth)acrylate copolymer, and a copolymer obtained by reacting a polyolefin-allyl glycidyl ether and/or a polyolefin and glycidyl (meth)acrylate or allyl glycidyl ether together with an organic peroxide to perform graft polymerization. Specific examples thereof include: an ethylene-glycidyl (meth)acrylate copolymer; an ethylene-vinyl acetate-glycidyl (meth)acrylate copolymer; ethylene-acrylate-glycidyl (meth)acrylate copolymers, such as an ethylene-methyl acrylate-glycidyl (meth)acrylate copolymer, an ethylene-ethyl acrylate-glycidyl (meth)acrylate copolymer, and an ethylene-butyl acrylate-glycidyl (meth)acrylate copolymer; an ethylene-acrylic acid-acrylate-glycidyl (meth)acrylate copolymer; an ethylene-methacrylate-glycidyl (meth)acrylate copolymer; an ethylene-methacrylic acid-methacrylate copolymer-glycidyl (meth)acrylate copolymer; an ethylene-polypropylene-glycidyl (meth)acrylate graft copolymer; an ethylene-polypropylene-diene copolymer-glycidyl (meth)acrylate graft copolymer; an ethylene-α-olefin copolymer-glycidyl (meth)acrylate graft copolymer; an ethylene-vinyl acetate copolymer-glycidyl (meth)acrylate graft copolymer; a polypropylene-glycidyl (meth)acrylate copolymer; and a polypropylene-glycidyl (meth)acrylate graft copolymer. Of those, an ethylene-glycidyl (meth)acrylate copolymer, an ethylene-vinyl acetate-glycidyl (meth)acrylate copolymer, an ethylene-acrylate-glycidyl (meth)acrylate copolymer, an ethylene-polypropylene-glycidyl (meth)acrylate graft copolymer, an ethylene-polypropylene-diene copolymer-glycidyl (meth)acrylate graft copolymer, a polypropylene-glycidyl (meth)acrylate copolymer, and a polypropylene-glycidyl (meth)acrylate graft copolymer are preferable.

The content ratio of the component (B) in the composition for a fiber-reinforced resin according to one embodiment of the invention is preferably from 10 parts by mass to 90 parts by mass, and more preferably from 15 parts by mass to 85 parts by mass, in 100 parts by mass in total of the component (A) and the component (B).

Note that, in the composition for a fiber-reinforced resin according to one embodiment of the invention, when the component (A) and the component (B) satisfy reaction conditions, a polymer including a structural unit derived from at least one functional group selected from the group consisting of an amino group, an epoxy group, a carboxyl group, an oxazoline group, and an acid anhydride structure is synthesized in some cases. That is, the composition for a fiber-reinforced resin according to one embodiment of the invention may take one of the following three forms (a) to (c).

(a) A form in which the component (A) and the component (B) exist independent of each other without reacting with each other.
(b) A form in which all of the component (A) and the component (B) react, and only the polymer including a structural unit derived from at least one functional group selected from the group consisting of an amino group, an epoxy group, a carboxyl group, an oxazoline group, and an acid anhydride structure exists.
(c) A form in which the unreacted component (A) and/or the unreacted component (B), and the polymer including a structural unit derived from at least one functional group selected from the group consisting of an amino group, an epoxy group, a carboxyl group, an oxazoline group, and an acid anhydride structure coexist.

An investigation made by the inventors of the present invention has revealed that it is difficult, even with an advanced analytical technology, to determine which of the forms (a) to (c) the composition for a fiber-reinforced resin according to one embodiment of the invention exists in.

1.3. Thermoplastic Resin (C)

The composition for a fiber-reinforced resin according to one embodiment of the invention may include a thermoplastic resin (C). The component (C) serves as an essential component in the production of the fiber-reinforced resin to be described later, but at least part of the component (C) may be added in advance to the composition for a fiber-reinforced resin, for producing the fiber-reinforced resin.

Examples of the component (C) include an olefin-based resin, a polyester-based resin, such as polyethylene terephthalate, polybutylene terephthalate, and polylactic acid, an acrylic-based resin, a styrene-based resin, such as polystyrene, an AS resin, and an ABS resin, a polyamide, such as nylon 6, nylon 6,6, nylon 12, a semi-aromatic polyamide (nylon 6T, nylon 61, and nylon 9T), and a modified polyamide, a polycarbonate, a polyacetal, a fluororesin, a modified polyphenylene ether, a polyphenylene sulfide, a polyester elastomer, a polyarylate, a liquid crystal polymer (wholly aromatic liquid crystal polymer and semi-aromatic liquid crystal polymer), a polysulfone, a polyethersulfone, a polyether ether ketone, a polyetherimide, a polyamide-imide, a polyimide, and a polyurethane-based resin. Those thermoplastic resins may be used either alone or in combination. Of those, an olefin-based resin is suitable from the viewpoint that mutual solubility with the component (A) is improved.

The weight average molecular weight (Mw) of the component (C) is preferably 5,000 or more and 1,000,000 or less. The ratio (Mw/Mn) of the weight average molecular weight (Mw) to the number average molecular weight (Mn) of the component (C) is not particularly limited, but is preferably 1 or more and 10 or less.

An olefin-based resin to be suitably used in one embodiment of the invention is described below.

Examples of the olefin-based resin include: a homopolymer of an alpha-olefin having about 2 to 8 carbon atoms, such as ethylene, propylene, and 1-butene; a binary or ternary (co)polymer of an alpha-olefin having about 2 to 8 carbon atoms, such as ethylene, propylene, and 1-butene, and an alpha-olefin having about 2 to 18 carbon atoms, such as ethylene, propylene, 1-butene, 3-methyl-1-butene, 1-pentene, 4-methyl-1-pentene, 4,4-dimethyl-1-pentene, 1-hexene, 4-methyl-1-hexene, 1-heptene, 1-octene, 1-decene, and 1-octadecene; and the like.

Specific examples of the olefin-based resin include: resins including: an ethylene-based resin, such as an ethylene homopolymer, an ethylene-propylene copolymer, an ethylene-1-butene copolymer, an ethylene-propylene-1-butene copolymer, an ethylene-4-methyl-1-pentene copolymer, an ethylene-1-hexene copolymer, an ethylene-1-heptene copolymer, and an ethylene-1-octene copolymer; a propylene-based resin, such as a propylene homopolymer, a propylene-ethylene copolymer, and a propylene-ethylene-1-butene copolymer; a 1-butene-based resin, such as a 1-butene homopolymer, a 1-butene-ethylene copolymer, and a 1-butene-propylene copolymer; and a 4-methyl-1-pentene-based resin, such as a 4-methyl-1-pentene homopolymer and a 4-methyl-1-pentene-ethylene copolymer; and the like.

Those olefin-based resins may be used either alone or in combination. Of those, an ethylene-based resin and a propylene-based resin are preferable, and a propylene-based resin is more preferable. In particular, when the component (A) is a block polymer that includes a conjugated diene polymer block that includes a repeating unit derived from a conjugated diene in a ratio of 80 mass % or more, and has a vinyl bond content of 30 mol % or more and 90 mol % or less, a propylene-based resin exhibits particularly excellent mutual solubility with the component (A). In this case, the vinyl bond content in the polymer block is more preferably 50 mol % or more and 90 mol % or less. It is preferable to hydrogenate the component (A) because mutual solubility and molecular entanglement with a propylene-based resin are significantly improved.

The weight average molecular weight (Mw) of the olefin-based resin is preferably 5,000 or more and 1,000,000 or less in order to improve the mechanical strength of the formed article. The ratio (Mw/Mn) of the weight average molecular weight (Mw) to the number average molecular weight (Mn) of the olefin-based resin is preferably 1 or more and 10 or less.

1.4. Age Resistor

The composition for a fiber-reinforced resin according to one embodiment of the invention may include an age resistor. The content of the age resistor is preferably from 0.01 parts by mass to 10 parts by mass, and more preferably from 0.02 parts by mass to 8 parts by mass, based on 100 parts by mass of the composition for a fiber-reinforced resin. When the content of the age resistor falls within the above-mentioned range, the flexural strength and Charpy impact strength, and forming external appearance of the formed article are improved.

Examples of the age resistor in the composition for a fiber-reinforced resin according to one embodiment of the invention include a hindered amine-based compound, a hydroquinone-based compound, a hindered phenol-based compound, a sulfur-containing compound, a phosphorus-containing compound, a naphthyl amine-based compound, a diphenyl amine-based compound, a p-phenylenediamine-based compound, a quinoline-based compound, a hydroquinone derivative-based compound, a monophenol-based compound, a bisphenol-based compound, a trisphenol-based compound, a polyphenol-based compound, a thiobisphenol-based compound, a hindered phenol-based compound, a phosphite-based compound, an imidazole-based compound, a nickel dithiocarbamate-based compound, and a phosphoric acid-based compound. Those age resistors may be used either alone or in combination.

In addition, commercially available products may also be used as the age resistor. Examples thereof may include products available under the trade names “ADK STAB AO-60”, “ADK STAB 2112”, and “ADK STAB AO-412S” manufactured by Adeka Corporation.

1.5. Additional Component

The composition for a fiber-reinforced resin according to one embodiment of the invention may include an additional component (e.g., water, metal atom, antioxidant, weatherproof agent, light stabilizer, thermal stabilizer, UV absorber, antibacterial/antifungal agent, deodorant, conductive agent, dispersant, softener, plasticizer, cross-linking agent, co-cross-linking agent, vulcanizing agent, vulcanization aid, blowing agent, blowing aid, colorant, flame retardant, damping agent, nucleating agent, neutralizer, lubricant, anti-blocking agent, dispersant, flow improver, and release agent) in addition to the components described above.

When the composition for a fiber-reinforced resin according to one embodiment of the invention includes water, the water content of the composition for a fiber-reinforced resin is preferably from 100>10⁻⁴ parts by mass to 50,000×10⁻⁴ parts by mass, and more preferably from 120×10⁻⁴ parts by mass to 40,000×10⁻⁴ parts by mass, based on 100 parts by mass in total of the component (A) and the component (B). Note that, in the invention of the present application, the “water content of the composition for a fiber-reinforced resin” has the same meaning as the water content of pellets of the composition for a fiber-reinforced resin.

The water content in the invention of the present application is a value measured in accordance with JIS K7251 “Plastics-Determination of water content”. The water content of the composition for a fiber-reinforced resin may be controlled by subjecting the composition for a fiber-reinforced resin to a heat treatment using a pellet dryer, such as a dehumidifying dryer, a vacuum dryer, or a hot-air dryer, at a temperature appropriate for the composition for a fiber-reinforced resin to be used, for a period of time appropriate therefor.

When the composition for a fiber-reinforced resin according to one embodiment of the invention includes a metal atom, the content of the metal atom is preferably from 0.3 ppm to 3,000 ppm, and more preferably from 0.5 ppm to 2,500 ppm, in 100 mass % of the composition for a fiber-reinforced resin. The content of the metal atom is preferably from 0.2×10⁻⁴ parts by mass to 4,000×10⁻⁴ parts by mass, and more preferably from 0.9×10⁻⁴ parts by mass to 3,400×10⁻⁴ parts by mass, based on 100 parts by mass in total of the component (A) and the component (B).

The form of the metal atom is not limited, and the metal atom may be added as a metal salt, a metal complex, a metal hydrate, an organic metal, or an inorganic metal, and only needs to be included at the above-mentioned concentration in the composition for a fiber-reinforced resin. Examples of the metal compound containing such metal atom include: polyvalent metal atom-containing compounds, such as an iron nitrate (ferrous nitrate or ferric nitrate), an iron sulfate (ferrous sulfate or ferric sulfate), an iron chloride (ferrous chloride or ferric chloride), iron(III) ferrocyanide, a trivalent iron chelate complex, aluminum sulfate, aluminum chloride, aluminum nitrate, potassium aluminum sulfate, aluminum hydroxide, magnesium chloride, magnesium sulfate, magnesium nitrate, potassium magnesium sulfate, calcium chloride, calcium nitrate, zinc chloride, zinc nitrate, zinc sulfate, barium chloride, barium nitrate, copper nitrate, copper(II) sulfate, copper chloride (cupric chloride), titanium oxide, titanium sulfide, titanium chloride, nickel sulfate, nickel(II) acetylacetonate, and alum; and compounds each containing a monovalent metal atom, such as lithium hydroxide, lithium chloride, and methoxylithium.

1.6. Production Method for Composition

The composition for a fiber-reinforced resin according to one embodiment of the invention may be produced by mixing or melt-mixing the component (A), the component (B), and as required, the component (C) and an additional component.

### 2. Fiber-Reinforced Resin

The fiber-reinforced resin according to one embodiment of the invention includes the above-mentioned composition for a fiber-reinforced resin, a thermoplastic resin (C), and carbon fibers (D).

2.1. Thermoplastic Resin (C)

As the thermoplastic resin (C), a resin similar to the thermoplastic resin (C) described above may be used. When the composition for a fiber-reinforced resin includes the thermoplastic resin (C), the same thermoplastic resin (C) as that of the composition for a fiber-reinforced resin is preferably used.

2.2. Carbon Fibers (D)

Normally, when a load (e.g., flexural load) is applied to an FRP formed article, adhesion between the fibers and the matrix resin is liable to become insufficient, and cracks are liable to occur at an interface between the fibers and the matrix resin. The cracks that have thus occurred are sometimes propagated to other interfaces between the fibers and the matrix resin to induce cracks across the formed article, whereby the formed article breaks. However, it has been revealed that, by incorporating the above-mentioned composition for a fiber-reinforced resin, the adhesion between the component (C) and the component (D) is improved, and thus it is possible to effectively improve mechanical properties (e.g., flexural strength and impact resistance).

The carbon fibers (D) in the present invention may be a non-woven fabric. The non-woven fabric refers to a form in which strands and/or monofilaments of fibers (the strands and the monofilaments are hereinafter collectively referred to as fine-denier strands) are dispersed in a plane with void portions. Examples thereof may include a chopped strand mat, a continuous strand mat, a paper-making mat, a carded mat, and an air-laid mat. The strands are each an assembly of a plurality of single fibers arranged in parallel, and are also called fiber bundles. In the component (D), the fine-denier strands normally have no regularity in their dispersion state. The use of the component (D) increases steric hindrance between the fibers, and hence can efficiently decrease the ratio of the fibers. The use of the component (D) also provides excellent formability, and hence facilitates forming into a complex shape. The voids in the component (D) complicate the progress of resin impregnation, and hence the component (A) and the component (C) described later form a more complex interface to express excellent adhesion.

It is preferable that, in the component (D), fibers be substantially in the form of monofilaments. The phrase “dispersed substantially in the form of monofilaments” used herein means that fibers forming the component (D) include 50 wt % or more of fine-denier strands each including less than 100 filaments. It is also preferable that the fibers be randomly dispersed in the component (D). Such component (D) may be produced using a known method. For example, the method disclosed in JP-A-2014-196584 or JP-A-2014-125532 may be used.

Recycled fibers may be used as the fibers contained in the component (D). The recycled fibers refer to reusable fibers out of recovered fibers obtained by removing a matrix resin from a waste fiber-reinforced resin (FRP), and then recovering fiber portions thereof.

Normally, as a resin decomposition method to be used in the recovery of fibers from the FRP, there are given methods such as thermal decomposition, chemical decomposition, and photodecomposition. However, irrespective of which of the methods is used, a sizing agent may be removed through thermal decomposition, photodecomposition, or the like in the treatment process, or functional groups on the surfaces of the carbon fibers may disappear. Accordingly, when regenerated fibers recovered by recycling are reused as an FRP, the mechanical properties (e.g., impact resistance and flexural strength) of the FRP are significantly degraded as compared to those obtained when unused fibers are added. However, even when the recycled fibers are used, by incorporating the above-mentioned composition for a fiber-reinforced resin and the component (C), it is possible to improve the mechanical properties (e.g., impact resistance and flexural strength).

It is preferable that the component (D) have a fiber length of 1 mm or more and 200 mm or less. The lower limit of the fiber length of the component (D) is preferably 2 mm, and more preferably 3 mm. The upper limit of the fiber length of the component (D) is preferably 100 mm, and more preferably 50 mm.

The lower limit of the fiber diameter of the component (D) is preferably 1 nm, more preferably 5 nm, and particularly preferably 10 nm. The upper limit of the fiber diameter of the component (D) is preferably 10 mm, more preferably 5 mm, still more preferably 3 mm, and particularly preferably 1 mm.

The fiber length and fiber diameter of the component (D) may be measured by a known method. For example, the fiber length and fiber diameter may be measured by observing the fibers using a microscope. The fiber length and fiber diameter of the component (D) in the FRP formed article may be measured by subjecting the formed article to a high-temperature ashing treatment, a dissolution treatment using a solvent, a decomposition treatment using a reagent, or the like to collect a filler residue, and observing the filler residue using a microscope.

The ratio (aspect ratio) of the fiber length to the fiber diameter of each of the fibers contained in the component (D) is preferably from 140 to 30,000, and more preferably from 400 to 7,500. When the aspect ratio falls within the above-mentioned range, it is possible to further improve the mechanical properties of the formed article. When the aspect ratio falls within the above-mentioned range, it is possible to prevent a situation in which the formed article is deformed or becomes anisotropic, and ensure that the formed article exhibits satisfactory external appearance.

The lower limit of a mass per unit area suitable for the non-woven fabric of the component (D) is preferably 50 g/cm³, and more preferably 80 g/cm³. The upper limit of the mass per unit area suitable for the component (D) is preferably 300 g/cm³, and more preferably 250 g/cm³.

Preferable examples of the component (D) include PAN-based carbon fibers produced using polyacrylonitrile fibers as a raw material, pitch-based carbon fibers produced using coal tar or petroleum pitch as a raw material, cellulose-based carbon fibers produced using viscose rayon, cellulose acetate, or the like as a raw material, vapor-grown carbon fibers produced using a hydrocarbon or the like as a raw material, graphitized fibers thereof, and the like. Those components (D) may be used either alone or in combination.

The component (D) may have a surface optionally modified with a functional group. Examples of such functional group include a (meth)acryloyl group, an amide group, an amino group, an isocyanate group, an imide group, a urethane group, an ether group, an epoxy group, a carboxyl group, a hydroxyl group, and an acid anhydride structure.

The functional group may be introduced into the carbon fibers using an arbitrary method. For example, the functional group may be introduced into the carbon fibers using a method that introduces the functional group into the carbon fibers by directly reacting the carbon fibers and a sizing agent, a method that applies a sizing agent to the carbon fibers, or impregnates the carbon fibers with a sizing agent, and optionally solidifies the sizing agent, or the like. More specifically, the functional group may be introduced into the carbon fibers using the method disclosed in JP-A-2013-147763 or the like.

As the kind of the sizing agent, there are given, for example, one or two or more selected from the group consisting of an acid, an acid anhydride, an alcohol, a halogenation reagent, an isocyanate, an alkoxysilane, cyclic ethers, such as oxirane (epoxy), an epoxy resin, a urethane resin, a urethane-modified epoxy resin, an epoxy-modified urethane resin, an amine-modified aromatic epoxy resin, an acrylic resin, a polyester resin, a phenol resin, a polyamide resin, a polycarbonate resin, a polyimide resin, a polyetherimide resin, a bismaleimide resin, a polysulfone resin, a polyethersulfone resin, a polyvinyl alcohol resin, and a polyvinylpyrrolidone resin.

2.3. Content Ratio of Each Component

In the fiber-reinforced resin according to one embodiment of the invention, the lower limit of the total content ratio of the component (A) and the component (B) is preferably 0.1 parts by mass, and more preferably 0.5 parts by mass, based on 100 parts by mass of the component (C) serving as the matrix resin. The upper limit of the total content ratio of the component (A) and the component (B) is preferably 15 parts by mass, more preferably 10 parts by mass, and particularly preferably 5 parts by mass, based on 100 parts by mass of the component (C) serving as the matrix resin. When the total content ratio of the component (A) and the component (B) falls within the above-mentioned range, the component (A) and the component (B) can strongly bond the component (C) to the component (D). It is considered that, as a result, the occurrence of cracks at the interface between the component (C) and the component (D) when a load (e.g., flexural load) is applied is suppressed, and the mechanical strength (e.g., flexural strength and Charpy impact strength) of the formed article is improved.

In the fiber-reinforced resin according to one embodiment of the invention, the lower limit of the content ratio of the component (D) is preferably 10 parts by mass, more preferably 30 parts by mass, and particularly preferably 50 parts by mass, based on 100 parts by mass of the component (C) serving as the matrix resin. The upper limit of the content ratio of the component (D) is preferably 150 parts by mass, and more preferably 100 parts by mass. When the content ratio of the component (D) falls within the above-mentioned range, it is possible to improve the mechanical strength (e.g., flexural strength and falling weight impact strength) of the resulting formed article.

2.4. Production Method for Fiber-Reinforced Resin

The fiber-reinforced resin according to one embodiment of the invention may be produced by impregnating the component (D) with the above-mentioned composition for a fiber-reinforced resin, the component (C), and as required, an additional component. The impregnation method is not particularly limited, and the composition for a fiber-reinforced resin and the component (C) may be mixed before the impregnation of the component (D) in the mixture.

### 3. Formed Article

The formed article according to one embodiment of the invention is obtained by forming the fiber-reinforced resin described above. In the forming, it is preferable to select forming conditions under which breakage of the fibers included in the fiber-reinforced resin according to one embodiment of the invention can be suppressed. As forming conditions for maintaining the fiber length as much as possible, it is desirable to reduce shearing due to plasticization, by, for example, setting the temperature so as to be higher than a normal plasticizing temperature during forming under a state in which the matrix resin does not have added thereto reinforcing fibers (unreinforced) by from 10° C. to 30° C. When conditions under which the fiber length is increased are adopted for the forming as described above, it is possible to achieve a resin formed article reinforced by the fibers dispersed in the formed article formed from the fiber-reinforced resin according to one embodiment of the invention.

A known method may be applied as the forming method. Conditions under which the shearing of the fibers due to plasticization is reduced may be appropriately selected. For example, an injection forming method, an extrusion method, a blow forming method, a foaming method, a pressing method, or the like may be used. The component (D) may be formed in advance to have the desired shape (e.g., sheet-like shape), and impregnated with a mixture including the composition for a fiber-reinforced resin and the component (C) that have been melted to produce a formed article.

The formed article according to one embodiment of the invention that has the above-mentioned properties may be suitably used as an automotive material (e.g., automotive interior material, skin, and bumper), a housing used for a home electrical product, a home appliance material, a packing material, a constructional material, a civil engineering material, a fishery material, other industrial materials, and the like. In addition, it is possible to use the formed article as an electromagnetic absorption material by adjusting the degree of orientation of the carbon fibers within the resin.

### 4. Examples

The invention is specifically described below by way of Examples. Note that the invention is not limited to the following Examples. The unit “parts” used in connection with Examples and Comparative Examples refers to “parts by mass”, and the unit “%” used in connection with Examples and Comparative Examples refers to “mass %” unless otherwise indicated.

4.1. Weight Average Molecular Weight (Mw) of Polymer

The weight average molecular weight (Mw) (polystyrene-equivalent weight average molecular weight) was determined by gel permeation chromatography (GPC) using a system “PL-GPC220” manufactured by Agilent Technologies.

Eluant: o-dichlorobenzene

Measurement temperature: 135° C.

Column: PLgel Olexis

### 4.2. Example 1

4.2.1. Production of Pellets

0.1 parts by mass of pentaerythritol tetrakis[3-(3,5-di-tert-butyl-4-hydroxyphenyl)propionate] (trade name: “ADK STAB AO-60”, manufactured by Adeka Corporation), and 0.1 parts by mass of tris(2,4-di-tert-butylphenyl)phosphite (trade name: “ADK STAB 2112”, manufactured by Adeka Corporation) serving as age resistors were added to 100 parts by mass in total of the component (A) and the component (B) (see Table 1 for their types and numbers of parts by mass). Then, the mixture was fed to a twin-screw extruder “TEM26SS” (model name) manufactured by Toshiba Machine Co., Ltd. and melt-mixed under the conditions of a cylinder temperature of 230° C., a screw revolution number of 300 rpm, and a discharge rate of 30 kg/h to obtain cylindrical pellets each having a diameter of 2 mm and a length of 4 mm.

The produced undried pellets were dried using a dryer (trade name: “parallel-flow batch dryer”, manufactured by Satake Chemical Equipment Mfg., Ltd.) under the condition of a drying temperature of 80° C. until a water amount of 150 ppm was achieved. Thus, pellets were produced.

4.2.2. Production of Formed Article

100 parts by mass of the above-mentioned pellets, 5,000 parts by mass of pellets of “NOVATEC MA1B” (polypropylene, manufactured by Japan Polypropylene Corporation), and 2,600 parts by mass of “HT C702” (PAN-based carbon fibers, manufactured by Toho Tenax Co., Ltd.) were fed to a twin-screw extruder “TEM26SS” (model name) manufactured by Toshiba Machine Co., Ltd. and melt-mixed under the conditions of a cylinder temperature of 230° C., a screw revolution number of 700 rpm, and a discharge rate of 30 kg/h to obtain cylindrical fiber-reinforced resin pellets each having a diameter of 2 mm and a length of 4 mm.

The produced fiber-reinforced resin pellets were subjected to injection forming of the resin mixture using an injection forming machine having a clamping force of 110 tons (manufactured by The Japan Steel Works, LTD., product name: “J-110AD”) under the conditions of a cylinder temperature of 230° C. and a back pressure 10 MPa to produce a flat plate-shaped formed article measuring 150 mm (width)×150 mm (length)×2 mm (thickness).

4.2.3. Evaluation of Formed Article

### (1) Flexural Strength

The formed article produced above was cut using a universal cutter so as to have a size of 10 mm×150 mm×2 mm (=width×length×thickness) to prepare a specimen. The test was performed in accordance with ISO 179 under the conditions of a distance between supports of 64 mm and a testing speed of 2 mm/min. The test temperature was 23° C. The unit of the flexural strength is “MPa”. A case in which the flexural strength was 155 MPa or more was determined to be satisfactory, and a case in which the flexural strength was less than 155 MPa was determined to be unsatisfactory.

### (2) Charpy Impact Strength

The formed article produced above was cut using a universal cutter so as to have a size of 10 mm×80 mm×2 mm (=width×length×thickness) to prepare a specimen. The test was performed in accordance with JIS-K7077. The unit for the measurement of the Charpy impact strength is “kJ/m²”. A case in which the Charpy impact strength was 20 kJ/m² or more was determined to be satisfactory, and a case in which the Charpy impact strength was less than 20 kJ/m² was determined to be unsatisfactory.

### 4.3. Examples 2 to 12 and Comparative Examples 1 to 4

Formed articles were produced in the same manner as in Example 1 except that pellet compositions shown in Table 1 were adopted and fiber-reinforced resins shown in Table 1 were used, and the formed articles were evaluated in the same manner as in Example 1.

### 4.4. Evaluation Results

The compositions of the pellets and fiber-reinforced resins used in Examples and Comparative Examples, and the evaluation results of the formed articles are shown in Table 1.

TABLE 1

| | | | Example | Example | Example | Example | Example | Example | Example | Example |
|---|---|---|---|---|---|---|---|---|---|---|
| | | | 1 | 2 | 3 | 4 | 5 | 6 | 7 | 8 |
| Pellets | Block | Type | A1 | A1 | A1 | A1 | A1 | A2 | A3 | A3 |
| | polymer | Type of functional | Amino | Amino | Amino | Amino | Amino | Amino | None | None |
| | (A) | group | group | group | group | group | group | group | | |
| | | Weight average | 90,000 | 90,000 | 90,000 | 90,000 | 90,000 | 70,000 | 90,000 | 90,000 |
| | | molecular weight | | | | | | | | |
| | | Storage modulus | 6 | 6 | 6 | 6 | 6 | 175 | 220 | 220 |
| | | (MPa) | | | | | | | | |
| | | Parts by mass | 50 | 15 | 85 | 15 | 85 | 50 | 50 | 50 |
| | Polymer (B) | Type | B1 | B1 | B1 | B2 | B3 | B1 | B1 | B4 |
| | | Type of functional | Epoxy | Epoxy | Epoxy | Epoxy | Epoxy | Epoxy | Epoxy | Epoxy |
| | | group | group | group | group | group | group | group | group | group |
| | | Weight average | 280,000 | 280,000 | 280,000 | 60,000 | 330,000 | 280,000 | 280,000 | 238,000 |
| | | molecular weight | | | | | | | | |
| | | Parts by mass | 50 | 85 | 15 | 85 | 15 | 50 | 50 | 50 |
| | Age Resistor | Type | E1/E2 | E1/E2 | E1/E2 | E1/E2 | E1/E2 | E1/E2 | E1/E2 | E1/E2 |
| | | Parts by mass | 0.1/0.1 | 0.1/0.1 | 0.1/0.1 | 0.1/0.1 | 0.1/0.1 | 0.1/0.1 | 0.1/0.1 | 0.1/0.1 |
| | Additional | Type | — | — | — | — | — | — | — | — |
| | component | Type of functional | — | — | — | — | — | — | — | — |
| | | group | | | | | | | | |
| | | Weight average | — | — | — | — | — | — | — | — |
| | | molecular weight | | | | | | | | |
| | | Storage modulus | — | — | — | — | — | — | — | — |
| | | (MPa) | | | | | | | | |
| | | Parts by mass | — | — | — | — | — | — | — | — |
| Fiber- | Pellets | Parts by mass | 100 | 100 | 100 | 100 | 100 | 100 | 100 | 100 |
| reinforced | Thermoplastic | Type | PP | PP | PP | PP | PP | PP | PP | PP |
| resin | resin (C) | Parts by mass | 5,000 | 5,000 | 5,000 | 5,000 | 5,000 | 5,000 | 5,000 | 5,000 |
| | Carbon fibers | Type | D1 | D1 | D1 | D1 | D1 | D1 | D1 | D1 |
| | (D) | Fiber length (mm) | 6 | 6 | 6 | 6 | 6 | 6 | 6 | 6 |
| | | Parts by mass | 2,600 | 2,600 | 2,600 | 2,600 | 2,600 | 2,600 | 2,600 | 2,600 |
| Physical | Flexural | MPa | 165 | 162 | 170 | 162 | 162 | 162 | 165 | 169 |
| properties | strength | | | | | | | | | |
| of formed | Charpy impact | kJ/m² | 25 | 26 | 27 | 25 | 25 | 27 | 27 | 29 |
| article | strength | | | | | | | | | |
| | | | | | | | Comparative | Comparative | Comparative | Comparative |
| | | | Example | Example | Example | Example | Example | Example | Example | Example |
| | | | 9 | 10 | 11 | 12 | 1 | 2 | 3 | 4 |
| Pellets | Block | Type | A3 | A4 | A1 | A1 | A1 | — | — | — |
| | polymer | Type of functional | None | Amino | Amino | Amino | Amino | — | — | — |
| | (A) | group | | group | group | group | group | | | |
| | | Weight average | 90,000 | 100,000 | 90,000 | 90,000 | 90,000 | — | — | — |
| | | molecular weight | | | | | | | | |
| | | Storage modulus | 220 | 62 | 6 | 6 | 6 | — | — | — |
| | | (MPa) | | | | | | | | |
| | | Parts by mass | 50 | 50 | 30 | 30 | 100 | — | — | — |
| | Polymer (B) | Type | B5 | B1 | B6 | B7 | — | B7 | B1 | B1 |
| | | Type of functional | Epoxy | Epoxy | Oxazoline | Acid | — | Acid | Epoxy | Epoxy |
| | | group | group | group | group | anhydride | | anhydride | group | group |
| | | | | | | structure | | structure | | |
| | | Weight average | 147,000 | 280,000 | 160,000 | 45,000 | — | 45,000 | 280,000 | 280,000 |
| | | molecular weight | | | | | | | | |
| | | Parts by mass | 50 | 50 | 70 | 70 | — | 100 | 100 | 50 |
| | Age Resistor | Type | E1/E2 | E1/E2 | E1/E2 | E1/E2 | E1/E2 | E1/E2 | E1/E2 | E1/E2 |
| | | Parts by mass | 0.1/0.1 | 0.1/0.1 | 0.1/0.1 | 0.1/0.1 | 0.1/0.1 | 0.1/0.1 | 0.1/0.1 | 0.1/0.1 |
| | Additional | Type | — | — | — | — | — | — | — | HF77 |
| | component | Type of functional | — | — | — | — | — | — | — | None |
| | | group | | | | | | | | |
| | | Weight average | — | — | — | — | — | — | — | 100,000 |
| | | molecular weight | | | | | | | | |
| | | Storage modulus | — | — | — | — | — | — | — | 1,200 |
| | | (MPa) | | | | | | | | |
| | | Parts by mass | — | — | — | — | — | — | — | 50 |
| Fiber- | Pellets | Parts by mass | 100 | 100 | 100 | 100 | 100 | 100 | 100 | 100 |
| reinforced | Thermoplastic | Type | PP | PP | PP | PP | PP | PP | PP | PP |
| resin | resin (C) | Parts by mass | 5,000 | 5,000 | 5,000 | 5,000 | 5,000 | 5,000 | 5,000 | 5,000 |
| | Carbon fibers | Type | D1 | D1 | D1 | D1 | D1 | D1 | D1 | D1 |
| | (D) | Fiber length (mm) | 6 | 6 | 6 | 6 | 6 | 6 | 6 | 6 |
| | | Parts by mass | 2,600 | 2,600 | 2,600 | 2,600 | 2,600 | 2,600 | 2,600 | 2,600 |
| Physical | Flexural | MPa | 167 | 155 | 155 | 155 | 120 | 150 | 150 | 110 |
| properties | strength | | | | | | | | | |
| of formed | Charpy impact | kJ/m² | 28 | 24 | 22 | 22 | 18 | 16 | 19 | 15 |
| article | strength | | | | | | | | | |

Abbreviations of components in Table 1 mean the following components.

### <Block Polymer (A)>

A1: modified hydrogenated conjugated diene block polymer (SEBS block polymer) manufactured by JSR Corporation, trade name: “DR8660”

A2: amine-modified hydrogenated styrene-based thermoplastic elastomer (SEBS block polymer) manufactured by AGC Chemicals Company, trade name: “Taftec MP10”

A3: hydrogenated conjugated diene block polymer (SEBS block polymer) manufactured by JSR Corporation, trade name: “DR8900”

A4: modified hydrogenated conjugated diene polymer (SEBC block polymer) manufactured by JSR Corporation, trade name: “DR4660”

### <Polymer (B)>

B1: ethylene glycidyl methacrylate copolymer manufactured by Sumitomo Chemical Co., Ltd., trade name: “BF-E”

B2: ethylene glycidyl methacrylate copolymer manufactured by Sumitomo Chemical Co., Ltd., trade name: “BF-CG5001”

B3: ethylene glycidyl methacrylate copolymer manufactured by Sumitomo Chemical Co., Ltd., trade name: “BF-2C”

B4: poly(ethylene/glycidyl methacrylate)-graft-polystyrene manufactured by NOF Corporation, trade name: “MODIPER A4100”

B5: poly(ethylene/glycidyl methacrylate)-graft-poly(acrylonitrile/styrene) manufactured by NOF Corporation, trade name: “MODIPER A4400”

B6: oxazoline-modified polystyrene manufactured by Nippon Shokubai Co., Ltd., trade name: “EPOCROS RPS-1005”

B7: maleic anhydride-modified polypropylene manufactured by Sanyo Chemical Industries, Ltd., trade name: “UMEX 1001”

### <Additional Component>

HF77: polystyrene resin manufactured by PS Japan Corporation, trade name: “HF77”

### <Thermoplastic Resin (C)>

PP: polypropylene “NOVATEC MA1B” (trade name) manufactured by Japan Polypropylene Corporation

### <Carbon Fibers (D)>

D1: PAN-based carbon fiber “HT C702” (trade name) manufactured by Toho Chemicals Co., Ltd., average fiber length: 6 mm

### <Age Resistor>

E1: pentaerythritol tetrakis[3-(3,5-di-tert-butyl-4-hydroxyphenyl)propionate] manufactured by Adeka Corporation, trade name: “ADK STAB AO-60”

E2: tris(2,4-di-tert-butylphenyl)phosphite manufactured by Adeka Corporation, trade name: “ADK STAB 2112”

Note that the storage modulus of the block polymer (A) was measured as described below.

A pressed sheet having a thickness of 1 mm was produced with a press machine (model: “IPS37”) manufactured by Iwaki Industry Co., Ltd. A strip-shaped specimen having a width of 3 mm and a length of 4 cm was punched out of the produced pressed sheet, and was measured for its viscoelasticity using a viscoelasticity measurement apparatus (model: “RSA-GII”) manufactured by TA Instruments under an atmosphere at 23° C. and under a frequency of 1 Hz, and the average of storage moduli E′ (MPa) within the strain range of from 0.01% to 1% was determined.

According to each of Examples 1 to 12, a formed article improved in flexural strength and Charpy impact strength was obtained.

According to Comparative Example 1, because the component (B) was not included, the flexural strength and the Charpy impact strength were found to tend to be inferior to those obtained in Examples.

According to Comparative Examples 2 and 3, because the component (A) was not included, the flexural strength and the Charpy impact strength were found to tend to be inferior to those obtained in Examples.

According to Comparative Example 4, because the non-block polymer (HF77) was used in place of the component (A), the flexural strength and the Charpy impact strength were found to tend to be inferior to those obtained in Examples.

The invention is not limited to the embodiments described above. Various modifications and variations may be made of the embodiments described above. The invention includes various other configurations that are substantially the same as the configurations described above in connection with the embodiments (such as a configuration having the same function, method, and results, or a configuration having the same objective and results). The invention also includes configurations in which an unsubstantial element or the like described above in connection with the embodiments is replaced by another element or the like. The invention also includes a configuration having the same effects as those of the configurations described above in connection with the embodiments, or a configuration that is capable of achieving the same objective as that of the configurations described above in connection with the embodiments. The invention also includes a configuration in which a known technique is added to the configurations described above in connection with the embodiments.

1. A composition, comprising:
a block polymer (A); and
a polymer (B) comprising a functional group selected from the group consisting of an epoxy group, an oxazoline group, and an acid anhydride structure.

2. The composition according to claim 1, wherein the block polymer and the polymer each have a weight average molecular weight of 10,000 or more.

3. The composition according to claim 1, wherein the block polymer has a storage modulus under an atmosphere at 23° C. of 5 MPa or more.

4. The composition according to claim 1, wherein the block polymer comprises a styrene block.

5. A method for producing a composition, comprising
melt-mixing:
a block polymer; and
a polymer comprising a functional group selected from the group consisting of an epoxy group, an oxazoline group, and an acid anhydride structure.

6. The method according to claim 5, wherein the block polymer and the polymer each have a weight average molecular weight of 10,000 or more.

7. A fiber-reinforced resin, comprising:
the composition of claim 1;
a thermoplastic resin; and
carbon fibers.

8. A formed article, obtained by forming the fiber-reinforced resin of claim 7.
